(19) United States
(12) Patent Application Publication
(10) Pub. No.: US 2004/0063484 A1
(43) Pub. Date: Apr. 1, 2004

(54) Method and apparatus for wagering on contests

(76) Inventors: Thomas Scott Dreaper, Las Vegas, NV (US); Mark Yin, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/256,685

(22) Filed: Sep. 26, 2002

(51) Int. Cl. A63F 13/00

(52) U.S. Cl. 463/16

(57) ABSTRACT

A method and apparatus for wagering on a contest by making two or more event outcome selections from a group of two more events is disclosed. In one embodiment, a game card is provided having two or more event blocks containing events. A bettor submits a game card with a wager to become eligible to win a pool of wagers generated by multiple game card submissions. For the events on the game card, the bettor selects event outcomes. Upon occurrence of the contest, the event outcome selections on the game cards are compared to actual outcome resulting from the contest and points are assigned to accurate outcome selections. The game cards' point totals are compared; a bettor with the highest point totals is designated the winner. In one embodiment, the wagers are allocated to a general pool and a perfect ticket pool.

### FIELD OF THE INVENTION

The present invention relates to gaming and, in particular, to a method and apparatus for betting on outcomes of contests.

### BACKGROUND OF THE INVENTION

Gaming provides a significant source of revenue for governments and gaming operators, such as casinos. Although individuals may bet on any type contest, one form of gaming that has been widely accepted by the public is sports betting. In sports betting, a bettor will make a wager on a scheduled sporting event that a particular outcome will occur. Should the bettor's selected outcome and the resulting outcome coincide, the bettor receives a monetary award based on his wager. For example, a bettor may bet that his home baseball team will beat a visiting team. Should the visiting team be the favorite with odds of winning the game at 3 to 1, a winning payout to the bettor may be 3 times his wager. Hence, if the bettor bet $10, his winnings would be $30.

Although a bettor may win a multiple of the amount wagered, as in the above example, the multiple is usually a single or double digit multiplier. In the previous example, the amount won is $30 for a $10 bet. These types of bets provide a modest return to the bettor for the money wagered; however, the revenue generated by a casino or betting facility may be improved by introducing other types of games that may provide a larger payout given a small wager. Furthermore, games that yield a single payout, pool, or jackpot to a single individual may attract a large number of people for the opportunity of winning a pot of money.

Bingo is an example of a game in which one person wins a pot of money amongst a group of players that are typically located in a particular location such as a large room in a casino or bingo parlor. As a drawback to this type of game, there is a limit to the number of people that may participate, and as a result of the physical limitations of the gaming environment, the pot is limited. This limits the amount that the gaming facility may earn from the pot. Likewise, the limited pot size reduces a player's desire to play.

In other gaming situations, the wagers that are offered to the public may be undesirably confusing and hence inhibit new gamblers from wagering. For example, certain pari-mutuel type bets, such as trifecta, perfecta, or quinella, may be intimidating to new gamblers and thereby inhibit expansion of gaming or inhibit entry of new wagers to the gaming event.

In other instances, gamblers may be hesitant to make bets against a casino or other gaming location, hereinafter referred to as the “house,” based on a belief that they are unable to win against the experts employed by the house. As a result, these gamblers may not wager, or may instead bet on events that are not offered by the house. For example, the gambler may bet with friends, a local bookie, or participate in office pools. This has several drawbacks. First, this type of betting may be illegal, and bets may not reliably be paid. Second, the casino, other gaming institutions, and government entities are unable to profit from these types of betting arrangements.

Hence, an improved method and apparatus for gaming that attracts a large number of bettors, attracts new gamblers, and generates gaming revenue is needed. The method and apparatus described herein provides such a method and apparatus for gaming and overcomes the drawbacks of the prior art.

### SUMMARY OF THE INVENTION

The invention comprises a method and apparatus for wagering on a contest by selecting event outcomes. In one embodiment, a gaming card is provided to a bettor that defines one or more contests and one or more events associated with the contests. The events may comprise aspects of the contest upon which the bettor may bet. Utilizing the game card, the bettor makes the event outcome selections and submits the game card, with a wager, to a gaming facility, such as a casino. The gaming facility may collect numerous game cards from numerous bettors and submit the game cards, with associated wagers, to the gaming facility. The wagers submitted with each game card may be pooled into a common pool, such as a general pool or a perfect ticket pool.

Upon occurrence of the contest, the actual event outcomes may be compared to the outcome selections on the game card. Based on the comparison, the game cards are assigned point values. In one embodiment, point values are assigned to correct outcome selections. A winning game card is selected as the game card with the most points, and thus the bettor submitting the game card with the most points is awarded the pool of wagers. The gaming facility may take a percentage of the pool to cover operating expenses and a reasonable return on investment. The details associated with the method and apparatus for gaming are provided below.

This method and apparatus for wagering has numerous advantages over prior art wagering opportunities. One advantage occurs as a result of the pool of wagers that are awarded to a winner. As the number of bettors increases, the pool of potential winnings increases, and thus the potential for a bettor to win a very large sum of money increases. Since the bettor is able to win such a large sum of money for a rather minimal investment, there exists a large incentive to bet. This further increases betting, which further drives the interest level in the game. In general, the interest level increases exponentially as the pool gets larger. In contrast, the potential for attracting a large number of bets may not be realized in many games played by the casino or sports betting facility.

Not only does the bettor have the opportunity to win a large sum of money, but the amount collected by the gaming facility, which is often a percentage of the total pool, also increases. This provides more revenue for a generally fixed cost of administering the gaming card wagering event.

Yet another advantage is that bettors match their skill against other bettors and not the odds makers of the gaming facility. This allows bettors to believe that they have a better chance of winning, since it may be perceived to be easier to beat your co-worker or peer when betting than an expert employed by the gaming facility. This further increases betting and increases the pool, of which the gaming facility receives a percentage.

Another advantage of the method and apparatus described herein over the prior art is that it provides an alternative form of betting that may appeal to certain bettors who do not find current betting opportunities appealing or who find current betting rules confusing. For example, certain betting, such as on horse racing or certain casino games, may be undesirably complex. The game card system provides a simple and appealing method of wagering such that the wagering opportunities are provided on a gaming card or other media. Thus, the only selections available to the bettor are provided. Moreover, the events that are presented to the bettor may be made simple or complex by the gaming facility to suit the bettor's preferences. It is even contemplated that more than one game card may be presented, each having different events upon which to wager to thereby provide more accommodation to a bettor.

Other advantages will be apparent to one of ordinary skill in the art after reading the following description.

### DESCRIPTION OF THE DRAWINGS

FIG. 1A is an illustration of a generic game card that allows one to place a wager by making outcome selections of events characterized by multiple parameters.

FIG. 1B is an illustration of exemplary payouts for a mythical wager in a horse race contest.

FIG. 2 is an illustration of a game card used for betting in pari-mutuel type of sports.

FIG. 3A is an illustration of a game card used for betting in a team type of sports.

FIG. 3B is an embodiment of an example football game card.

FIG. 4A is an illustration of a game card used for betting in a match-up type of sports.

FIG. 4B is an embodiment of an example golf game card.

FIG. 5 is an illustration of an example system used for placing bets, processing collected bets, and distributing pay-outs in game card wagering.

FIGS. 6A and 6B illustrate an operational flow diagram of the process of placing bets, processing bets, and distributing monies in accordance with the invention.

### DETAILED DESCRIPTION OF THE INVENTION

A method and apparatus is disclosed for betting on event outcomes of contests and wherein a winner is the bettor possessing a highest number of outcomes, points, or credits calculated from all winning outcomes realized on a bettor's game card. In addition to payouts associated with a game card realizing a highest number of points, individuals possessing a game card or ticket realizing a maximum or predetermined number of outcomes, points, award, or credits may be awarded an additional accumulated payout. It is contemplated that these outcomes, points, awards or credits are determined after a contest or activity has ended. It is contemplated that the event outcomes may comprise any possible event outcome that is of interest to a bettor and the type of contests may comprise any type contest that generates event outcomes. While a sporting contest is one type of contest that may be bet upon, it is anticipated that any type of contest may generate the event outcomes. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

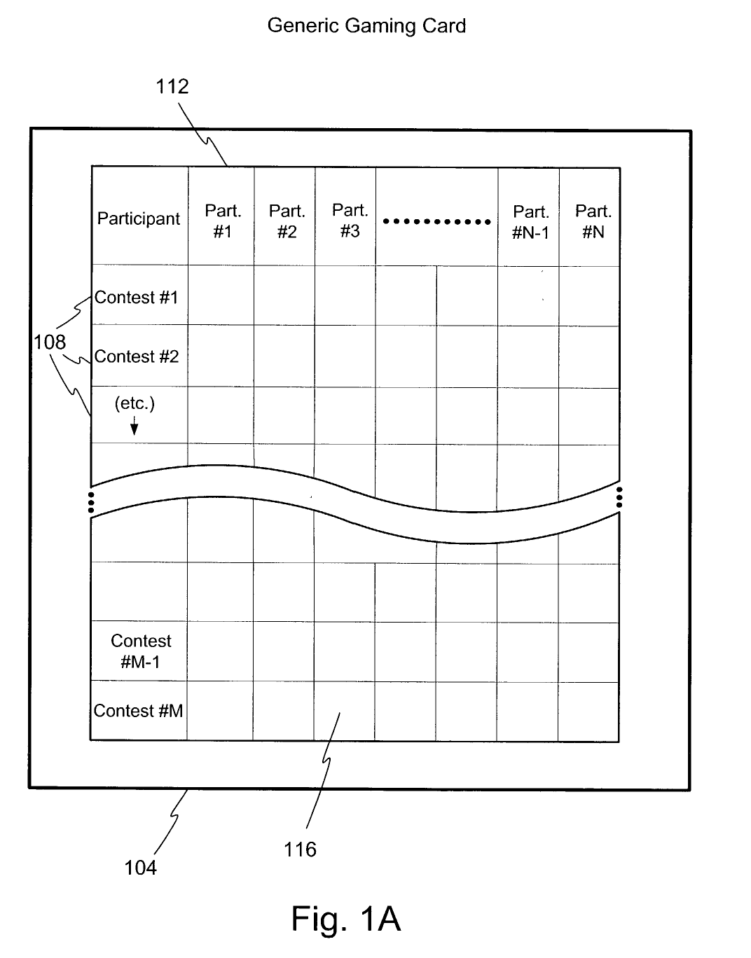

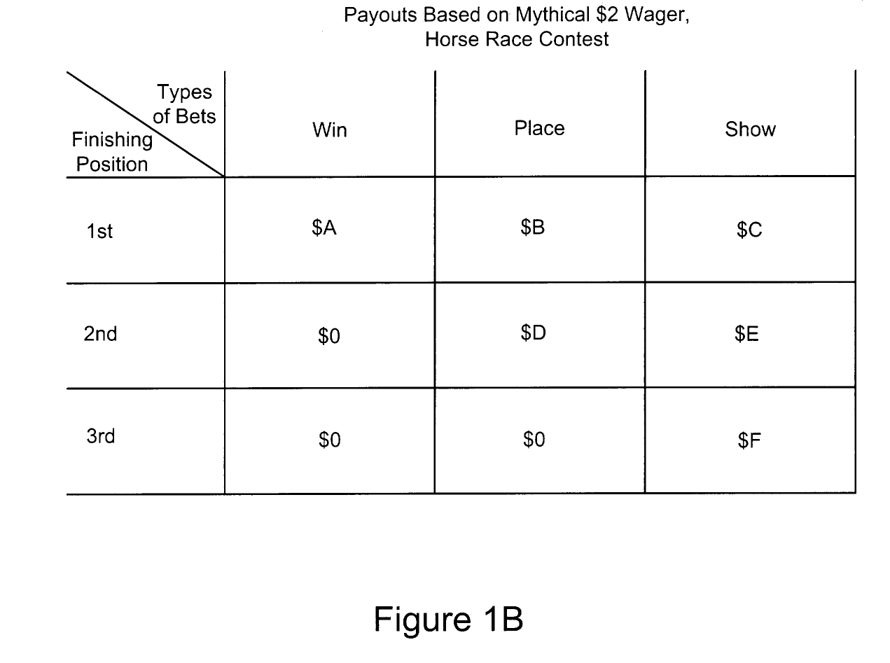

FIG. 1A illustrates one embodiment of a generic game card 104 used in betting at a gaming facility. The gaming facility may comprise a casino, a sports betting facility, a race track, an online gaming web-site or entity, a river boat casino, a gaming kiosk, a call in bet acceptance location, or any other location or entity that accepts wagers. The game card 104 comprises M+1 rows and N+1 columns, where the variables M and N comprise any positive integer. A first column may describe the sequence of contests to be held in a particular time frame. The sequence of contests may be identified by consecutive numbering. In other embodiments of the game card 104, the descriptions provided by the first column may not be used. The first row may describe the participants competing in the contests. In this embodiment, there are N participants listed. In other embodiments of the game card 104, the participants may not be displayed in the first row. The game card comprises a total of M×N event blocks 116. In this particular embodiment, the rows 108 may correspond to events concerning participants for a series of contests. For example, in the sport of horse racing, a row may represent one of several horse races involving two or more horses per race.

To aid in understanding, a discussion with examples of some terminology is now provided. Although examples are provided, these examples should not be construed to limit the scope of the terms or the claims. The term contest is defined to mean a competition amongst participants that yields a number of outcomes. Examples of contests include, but are not limited to, football games or other sports games; tournaments, such a golf or tennis tournaments; races, such as car, horse, or dog races; political elections; television occurrences; national or international events; natural events, such as weather; or any other event that may be bet upon.

Various events may be associated with contests. An example of an event may include, but is not limited to, the possible outcomes related to which a participant will win or rank in a contest played at a particular time in a specific location. Other examples of events include where a horse will finish in a race at a particular race track on a particular day. As is apparent, a contest may comprise numerous events, or stated another way, numerous events may occur during a contest, and these events have outcomes. By way of example, a single basketball game may have numerous events, such as the highest score at the end of each quarter of play between two teams on a particular day, the team with the highest final score between two teams on a particular day, the player with the highest number of points scored in a game on a specific day, etc.

Each event has more than one event outcome, which is the final determination as to an event. For example, if the event is defined as the winning team in a baseball game played between the Mets and the Dodgers, then the possible outcomes are the Mets win (Dodgers lose) or the Dodgers win (Mets lose). An event is characterized by one or more measurable or quantifiable parameters or factors generated by the participants of a contest. These parameters or factors provide decision points that permit a bettor to select the likelihood of the two or more outcomes.

In other sports, such as team oriented sports, a contest may refer to a competitive game between two teams or many players. A political election or television event may comprise a contest. A football game, baseball game, or golf tournament each may be referred to as a contest. The participants 112 may comprise an animal, a person, a team of animals, a team of players, a combination of one or more teams, a subset of one or more teams, or some other entity engaged in a particular contest in which a bettor may make outcome selections. It is contemplated that the one or more possible outcomes will be listed on the game card 104 within each block, such as event block 116. As illustrated in FIG. 1A, the participants or contest 112 in the game card are listed from left to right on the first row. A bettor may bet that a particular outcome associated with an event will occur in a contest.

The generic game card 104 comprises M×N number of event blocks 116. Each event block 116 provides a list of a number of outcomes related to an event associated with a contest. Each event block 116 corresponds to an event. During the betting process, a bettor makes an outcome selection regarding an event in the event block 116 from two or more possible outcomes that could result from an event block 116. After making the selections, the bettor submits the game card to a gaming entity or facilitator in charge of processing the gaming card 104.

As previously described, each event provides a bettor with a number of event outcomes that he may select. Each event is characterized by a number of parameters of which may comprise an occurrence parameter, time parameter, location parameter, and participant parameters. The occurrence parameter provides a measurable or quantifiable factor in a contest resulting in two or more outcomes. Examples of occurrence parameters include whether a specific team will win over an opponent, whether a rusher will surpass a particular rushing yardage, and whether a team will score over a predetermined number of points. The time parameter may describe a particular contest or time frame within the contest in which an event produces a particular outcome. Examples of time parameters include the first quarter in a basketball game, a football game that occurs on Sunday, or a particular hole in a golf game. The location parameter identifies the location of a contest when contests of the same sport may occur simultaneously or in similar time frames. Examples of location parameters include race tracks located in different cities, a team's division, or a particular leg of a race. The participant parameter indicates the parties, teams, individuals, or members that will affect the occurrence parameters of an event. Examples of participant parameters include an individual of a team, a team, a subset of a team, a combination of multiple players or teams, etc.

It is contemplated that the gaming entity or facilitator of the method and apparatus described herein will determine which contests to offer on the gaming card, the appropriate number of events or event blocks 116 per game card 104, the types of time, location, occurrence, and participant parameters that generate the appropriate types and numbers of outcome selections a bettor may make in a game card. Thus the designer of the game card selects the events upon which a bettor may select outcomes and which contests these events will be derived from. As the number of event blocks 116 in which a bettor must make outcome selections increases, the probability of attaining a perfect game card (i.e., a card in which he selects all correct outcomes) decreases. The concept of perfect game card is discussed below in more detail.

It is contemplated that in one embodiment, a bettor marks his outcome selections on the game card 104 using a marking tool such as a pen or pencil. The bettor may fill in a circle or check off a box located close to the outcome descriptions within each event block 116 on the game card 104. After his selections are made, the bettor provides his wager and the game card 104 to the gaming facilitator at a gaming location. It is contemplated the gaming facilitator may be a sports book office located at a casino, race track, sports contest location, online betting system, betting kiosk, off-track betting location, or any other location. Upon completion of a contest, the results may be manually, electronically, or otherwise posted on a board or a display, such as a monitor or scoreboard, so that the winning bettor(s) may verify or claim the award(s).

After the contest(s) ends, a winning game card must be determined. The winning game card comprises the game card 104 with the highest number of points, highest award, or highest number of correct outcome selections. A number of points are awarded to a game card per correct event outcome selections. For a pari-mutuel contest, such as horse racing, the award to the game card may be based on a mythical $2 bet per event outcome. The mythical monetary amount awarded for each correctly selected event outcome may be summed to generate a total mythical monetary award for the entire card. The card with the highest award is selected as the winning game card and a general pool of money generated from wagers associated with all the game cards bet on the contest(s) is given to the holder of the winning game card. In the event of a tie, the cards associated with the highest award is selected as the winning game cards and a general pool of money generated from wagers associated with the game card is given to the holders of the winning game cards.

A preferred embodiment of the use of a pari-mutuel type game card for a horse race type of contest is now disclosed. In this exemplary embodiment, the participant parameter corresponds to a single horse while each horse race corresponds to a single contest. In this embodiment, 3 horses are selected on the game card for a particular contest or horse race of which there are a total of 4 races. Hence, the bettor will make a total of 12 selections on the game card. It is contemplated that other embodiments may vary the number of horses selected per horse race or the number of horse races per game card, generating a variable number of event blocks that a bettor must select to complete the game card. The occurrence parameter is characterized by a horse's finishing position in a horse race. In this embodiment, the occurrence parameter is whether a horse selected by a bettor finishes within the top three positions or not. A winning outcome occurs when a selected horse finishes within the top three positions in a horse race. Points are awarded for each winning outcome selection based on a pari-mutuel payout system. After a race is completed, the awards corresponding to the race are calculated based on a particular horse's finishing position within the top three. Each winning outcome will be awarded one or more payout(s) corresponding to mythical $2 wagers.

FIG. 1B provides a table illustrating the award payouts to game cards that correctly select a horse finishing within the top three finishing positions. As an example of a winning outcome in which a bettor correctly selects a particular horse to finish within the top three finishers, an outcome in which a horse finishes in second place may be awarded points by summing the mythical amounts corresponding to a $2 place and a $2 show bet. In reference to FIG. 1B, the award for a horse finishing in this second finishing position equals $D+$E. A horse that finishes in first place (i.e., a win finish) may result in an award corresponding to the sum of a $2 win, a $2 place, and a $2 show bets. The corresponding award equals $A+$B+$C. When a horse finishes in the third position, the amount awarded for a winning event outcome is the mythical amount corresponding to a $2 show bet. In this instance, the corresponding amount awarded equals $F.

For the sake of a numerical exercise, a bettor selects horses #1, 7, and 9 to finish in the top three positions for horse race #1. At the end of horse race #1, Horse #1 actually wins, Horse #9 finishes in twelfth place, while Horse #7 finishes in third place. The game card award for horse race #1 would be equal to $A+$B+$C+$F.

This type of calculation is performed after each of the four horse races to provide a total award for the game card. Among all issued game cards, the game card(s) with the highest mythical monetary award wins the general pool of money associated with the game card. Game card(s) having all 12 winning outcomes realized will be awarded a perfect ticket pool of monies.

In one embodiment, one may assume a horse race contest in which 3 events are selected on a pari-mutuel type game card. In this example, Horse #1 is selected to win the race, Horse #7 is picked to show, while Horse #9 is selected to place. If each event selection corresponds to an actual event outcome in the contest, the awards are summed to provide a total award for the horse race in the game card. For example, the pari-mutuel odds established at the track or other gaming location may result in Horse #1 generating $7.20 to win on a $2 bet, Horse #7 generating $3.00 to show on a $2 bet, and Horse #9 generating $5.00 on a $2 bet. As a result, the horse race associated with the game card is awarded a mythical $15.20.

Other embodiments are contemplated incorporating variations of occurrence parameters to suit the preferences of the gaming card sport facilitators. These occurrence parameters may provide awards to event outcomes corresponding to exactas, trifectas, quinellas, or any other sequence or set of outcomes.

As discussed below in more detail, points may be awarded on a one-to-one basis for each correct outcome selection, or the points may be weighted such that some outcome selections result in more than one point being awarded. For example, if a bettor properly selects which team will win a contest, then they may be awarded a point, while if a bettor properly selects an unfavored horse to win, and that unfavored horse wins, then a greater number of points may be awarded for that event outcome selection. This may be referred to as point weighting.

After each game card is totaled, which is to say that each outcome selection is compared to the actual outcome of the event and an appropriate point total is assigned to each card, the total number of game cards, or a subset thereof, is compared to determine which game card has the greatest point total. For example, a bettor who made 13 correct outcome selections on a game card 104 having 15 events for which outcome selections were made may be awarded 13 points. Based on this comparison, a winner is determined. It is contemplated that there may exist more than one winner if two bettors submit game cards that are awarded the highest but equal number of points. Further, it is contemplated that there may exist sub-winners such that a winner may be determined for each casino property at which gaming cards are submitted. This provides the bettor more chances to win, albeit a smaller amount may be awarded per winner.

In one embodiment, a winner is awarded a general pool of money that comprises a portion or all of the total amount bet by bettors using identical game cards. It is contemplated that the general pool is generated through a pari-mutuel pool of wagers, although other forms of pooling of money and distribution may be implemented as well. It is contemplated that the rules and stipulations regarding the point calculation is regulated by a committee, such as a gaming control board or a pari-mutuel commission for a specific geography.

In instances in which two or more participants 112 (such as horses in a horse race) in a contest finish in a tie, it is contemplated that a clearinghouse, disseminating company, gaming card facilitator, or a race track (in the case of horse racing, dog racing, or jai-alai) determines appropriate pari-mutuel payoff awards. For example, in a horse racing sports contest, two, three, or multiple horses may tie for 1^{st} place. In such an occurrence, the resulting award to winning bettors may be predetermined or based on a pari-mutuel basis.

For example, in a horse racing contest, the first two finishing horses may tie for 1 St place. When this occurs, the bettors selecting winning outcomes may be granted an award based on a mythical $2 bet. The gaming facility may award game cards with such winning outcomes an appropriate amount of mythical dollars corresponding to the amounts collected per bet by the pari-mutuel wagering system. In other instances, the total mythical dollars awarded may be distributed in proportion to predetermined odds for each event outcome.

As stated above, each wagered game card 104 will be associated with a number of points after the contest(s) is completed. It is contemplated that points are awarded based on correct outcome selections and may be further based on the pari-mutuel odds associated with each correct outcome selection. It is contemplated that the pari-mutuel odds may act as weighting factors in the determination of points awarded per correct outcome selection. The game card(s) 104 with the highest number of points wins a general pool of money. This money is allocated based on collection of all wagers associated with the game card.

In some instances, a perfect ticket may occur. The term “perfect ticket” is defined as a game card that has a maximum number of winning outcomes, maximum number of points awarded, or has a “predetermined number of points” for a particular type of game card 104 after the outcomes in one or more contests are realized. If the gaming card facilitator awards points to a winning outcome, the card attaining a maximum number of points may be deemed the winner of the perfect ticket pool. The term “predetermined number of points” is defined to mean an award of a number of points that is less than the maximum possible for a game card but still wins the perfect ticket pool. In this instance, a perfect ticket pool is awarded although the maximum number of points is not attained. The gaming card facilitator may notify all bettors prior to a round of play regarding the number of outcomes or points required to attain a perfect ticket as an incentive to bettors. The gaming card facilitator may provide this type of information when a perfect ticket pool has not been awarded in a long time. Should a bettor possess a perfect ticket game card, the bettor may be awarded a pool of money reserved for a perfect ticket. In one embodiment, this pool is referred to as a “perfect ticket pool.” The details of the perfect ticket and the perfect ticket pool will be discussed below in the section entitled General and Perfect Ticket Pools.

Game Card for Pari-mutuel Sports

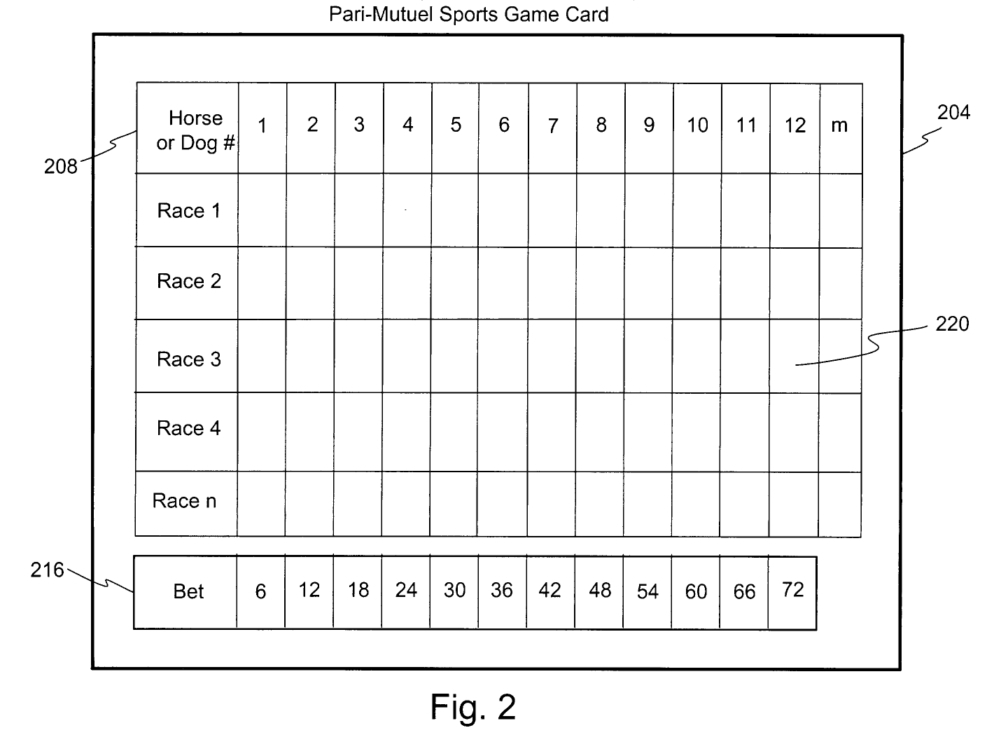

One example embodiment of a pari-mutuel game card 204 is shown in FIG. 2. The card 204 illustrates a betting mechanism used in a horse or dog racing contests, and jai-alai, in which a bettor may select one or more horses, dogs, or participants to finish in a particular order or other manner for each race. In one example embodiment, the bettor would select the first three finishers in each of four races or events. In this embodiment, the finishers may finish in any order within the top three places to qualify as winners. Points or a mythical monetary award may be made based on the pari-mutuel payout rates determined at the race or event. Scoring of this example embodiment is discussed below in more detail.

Relating this particular embodiment to the discussion provided above, various parameters characterize an event. The event may be described or characterized by one or more of an occurrence parameter, participant parameter, location parameter, and time parameter. In this example embodiment, the occurrence parameter is that a horse finishes within the top three finishers. The participant parameter is a horse within a number of horses running a race. The location parameter is a particular race track that a bettor may select. The time parameter is the date and race number the bettor may select. As illustrated in FIG. 2, a bettor will make selections amongst the various event blocks 220 in his game card 204. In this embodiment, he makes three selections. Each selection corresponds to one event. For example, if a bettor makes a selection on horse #12 (participant parameter) in race #2 (time parameter) at Hollywood Park (location parameter), he believes that this event will be realized as a positive outcome resulting in horse #12 finishing in either first, second, or third place (occurrence parameter).

It is contemplated that the game card 204 may be provided for any number of races. Thus a day of racing comprising twelve races may utilize 3 game cards 204, each of which allows the bettor to make outcome selections for four races. In this embodiment, the contests are races, while the events are represented by event blocks 220 in which selections may be made by the bettor. The bettor in this embodiment selects which horse or dog will finish in one of the top three positions of the contest. The horses or dogs are numbered from left to right in the first row 208 of the game card 204. As shown in this example embodiment, there are twelve horses, shown at the top row 208, participating in each of four races. As indicated in FIG. 2, it is contemplated that the number of participants in a game card (i.e., horses or dogs) may vary to a number, m while the number of races in a game card may vary to a number, n.

Near the bottom portion of the card 204 is a bet line 216 to designate the number of bets a bettor wishes to wager per game card 204. It is contemplated that this and other embodiments of game cards 204 may use this type of row to indicate the number of bets wagered prior to submitting a gaming card 204 to a game facilitator. In this embodiment, one wager is defined to be $6. Hence, three wagers would equate to $18. In other embodiments, one wager may be defined to be any monetary amount.

For the embodiment shown in FIG. 2, the game card 204 represents races #1-4 out of 12 races at a horse or dog racing track in a given day. As discussed above, based on 4 races per game card 204, with an average of 12 races per day, it is contemplated that there may be 3 different versions of game cards 204 per day for a particular track. For this particular horse racing contest, the game card 204 illustrates races 1-4 each having 12 horses per race for a total of 48 event blocks 220. It is contemplated that there may be a second version of the game card 204 corresponding to races #5-8, while a third version of game card 204 corresponds to races #9-12. It is expected that the example embodiment of a game card shown represents just one of many possible embodiments for a game card. Furthermore, while horse and dog racing have been discussed, it is contemplated that the same or similar principles may be applied to other forms of racing and other forms of pari-mutuel betting.

In terms of operation of the game card 204, bettors make selections on one or more horses or dogs per race that the bettor believes will satisfy particular criteria. For example, one such criterion may comprise being “in the money,” meaning that the horse or dog must finish either in the first, second, or third position. As disclosed earlier in FIG. 1B, in this example embodiment, a bettor selects three horses or dogs to finish in the top three (“in the money” or “win, place, or show in any order”) for each of four races. In this example method, a horse selected to finish within the top three finishers may be awarded the sum of mythical monetary payouts for a mythical $2 win, a $2 place, and a $2 show bet should the horse finish in the 1^{st} position (first place). In reference to FIG. 1B, this amount equals the sum $A+$B+$C. Should the horse finish in the 2^{nd} position the game card may be credited an mythical amount equivalent to the sum of a $2 place and a $2 show bet ($D+$E, as shown in FIG. 1B) while if the horse finishes in the 3^{rd} position the game card may be credited an appropriate number of points equivalent to a payout of a $2 show bet ($F, as in FIG. 1B).

It is contemplated that other event outcomes may be selected, such as but not limited to, any number of “in the money” positions. Hence, a varying number of points or award amount may be granted to a game card for correct outcome selections other than just win, place, or show. For example, a game card with a particular horse or other participant selected may be awarded five points if the horse or participant finishes first, four points for a second place finish, through one point for a fifth place finish. If the betting rules are such that a total of 3 outcomes selections are made per game card, a perfect ticket occurs when a maximum number of points is generated for a game card. The number of winning outcomes in the game card may be a maximum (in this instance, there are multiple ways to obtain 3 winning outcomes as there are 5 winning outcomes per contest), and the same number as that of another game card, although the points awarded may differ based on types of winning outcomes generated.

As opposed to a game that awards points for horses finishing “in the money,” the following embodiment provides a method of selecting outcomes based on an occurrence parameter characterized by a particular horse finishing in a particular position. In one embodiment, one may assume a horse race contest in which an exemplary 3 events are selected on a pari-mutuel type game card. For example, Horse #1 may be selected by the bettor to win the race, Horse #7 may be selected to show, while Horse #9 may be selected to place. If each event selection is realized as an actual event outcome in the contest, the point awards may be summed to provide a total award for the game card for that horse race. As a numerical example, the pari-mutuel odds established at the track or other gaming location may result in Horse #1 generating $7.20 to win on a $2 bet, Horse #7 generating $3.00 to show on a $2 bet, and Horse #9 generating $5.00 on a $2 bet. As a result, the horse race associated with the game card would be awarded a mythical $15.20. The winning outcomes of additional horse races as represented in the game card are calculated in like manner and points awarded per race are summed to provide a total award to the game card. The points awarded per game card are compared amongst all bettors in the selection of a general pool winner and perfect ticket winner.

The number of selectable event blocks 220 per game card 204 may be varied to suit the game operator's preference of having a bettor attain a perfect ticket in a population of bettors. It is contemplated that the number of events blocks 220 in a game card 204 may vary, although the embodiment shown comprises twelve event blocks 220 per race or event. In this case, a game card 204 comprising twelve winning outcome selections (i.e., three per race over four races) or a game card 204 having the highest point total over all winning outcomes may comprise either a winning general pari-mutuel pool card or winning perfect ticket or both. The number of participants selected per race and the number of contests (races) per game card 204 may be changed to suit the gaming operator's requirements.

It is further contemplated the gaming facilitators may vary the points awarded per successful event outcome to reflect the odds of occurrence for each outcome. For example, instead of the pari-mutuel odds determining the award to each ticket, other point values may be assigned to correct outcome selections. It is contemplated that there may be a multiplicity of outcomes per an event and each outcome may result in a distinct number of points awarded. The odds may be generated by a pari-mutuel betting system at a horse or dog race track or other facility capable of calculating odds based on all wagers made prior to a race. In one embodiment, the odds which are utilized for the game card point weighting are the same as that used during the actual horse or dog race pari-mutuel contest.

The points awarded for an outcome may vary based on predetermined weighting factors, pari-mutuel odds, or any other factor. For example, a winning event outcome in a horse race may be a quinella or trifecta. Thus, in one example embodiment the bettor may specify which horse must finish in which order. In this example event outcome, points would be credited to a game card 204 for those who correctly choose 3 horses that finish 1^{st}, 2^{nd}, or 3^{rd} in any order (as in the case of a quinella) or that the finishing positions of the first 3 horses come in a specific order (as in the case of a trifecta). The point payout per winning outcome may be assigned in proportion to the odds of attaining the quinella or trifecta. Since there is a higher probability of getting a quinella compared to a trifecta, the payout for a trifecta may be higher than that of a quinella. Moreover, the participants in the race that were selected may also alter the point weighting. For example, a trifecta may have odds of winning at 100-1 while a quinella may have odds of winning at 20-1. As a consequence, the mythical monetary points awarded may be $200.00 for a winning trifecta outcome vs. $40.00 for a winning quinella outcome. The following table represents various example event outcomes (based on pari-mutuel betting system) in a horse or dog racing contest, or other contest that adopts a similar type of betting scheme. The award, based on any example mythical monetary bet, would be based on the odds associated with a particular outcome or based on bets on the contest.

Type of Bets

| Outcomes | Points |
|---|---|
| Win | Award for finishing first |
| Place | Award for finishing second |
| Show | Award for finishing third |
| Win, place, show | Award for finishing first |
| Place, show | Award for finishing second |
| Exacta | Award for finishing first and second in exact order |
| Exacta box | Award for finishing exact order of more than two |
| | horses |
| Quinella | Award for finishing first and second in any order |
| Quinella box | Award for finishing first and second in any order of |
| | two or more horses |
| Trifecta | Award for finishing first, second and third in an exact |
| | order |
| Trifecta box | Award for finishing first, second and third in any order |
| Superfecta | Award for finishing first, second, third and fourth in |
| | exact order |
| Superfecta box | Award for finishing first, second, third and fourth in |
| | any order |
| Pick 6 | Award for finishing first in 6 races out of any number |
| | of races |
| Daily double | Award for finishing first in two races |
| Daily double box | Award for finishing first in two races for more than |
| | two horses |
| Multi-trifectas | Award for finishing first, second, and third in an exact |
| | order in more than one race |
| In the money | Award for finishing and being assigned a pari-mutuel |
| | award |

After a contest is completed, the sum of all awarded points to each game card will be compared for all outstanding game cards 204. The game card 204 values will be used to assess a winner of the general and perfect ticket pools. It should be noted that these point values are provided for purposes of example only and should not be construed to limit the scope of the terms or the claims.

Horse racing, dog racing, jai-alai, and the like are example contests upon which pari-mutuel type betting may occur. Other contests and hence may adopt this form of betting.

It is contemplated that the pari-mutuel game card 204 may comprise event blocks 220 corresponding to events located at different race tracks corresponding to one or more races. An example event may correspond to a horse or dog finishing within a particular place in a race at a particular race track. For example, a specific dog that is selected to finish at a particular finishing position or within the top three finishing positions for a particular race at a certain race track on a specific day corresponds to an event. If this event happens or is realized, the event becomes an outcome. If a bettor selects that horse #7 will show (finish within the top three finishers) at race #1 at the Churchill Downs race track on Oct. 8, 2002, he has specified an event. Should horse #7 finish in the top three, the event becomes an outcome. Since a location parameter (i.e., such as the Meadowlands or Hollywood Park, etc.), a time parameter (such as race and date) may also characterize an event or event block 220, the game card 204 may allow for the selection of multiple contests over various time frames at various locations. This may widen a bettor's preferences in terms of track and contest selectivity.

Game Card for Team Sports

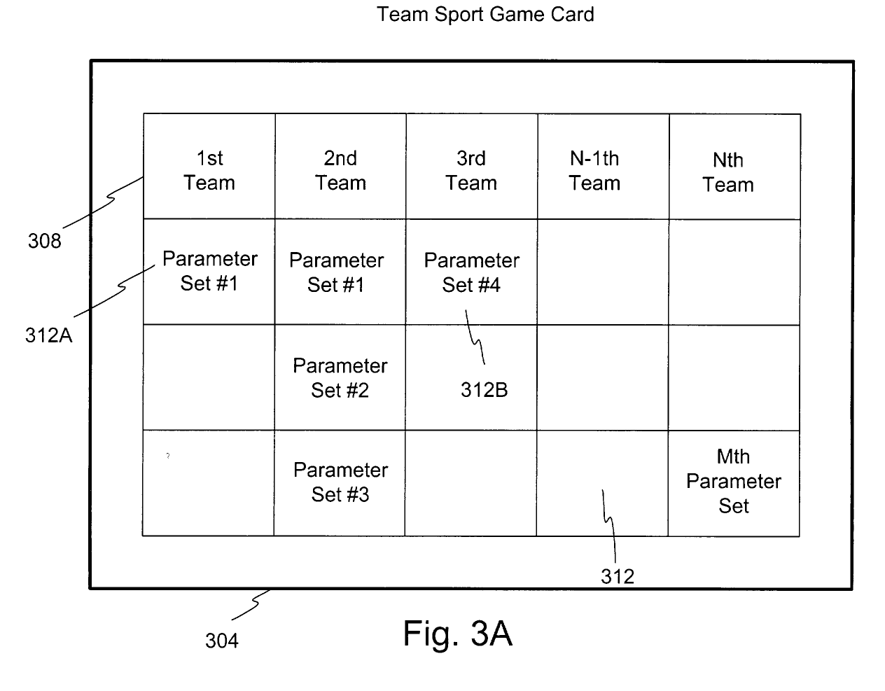

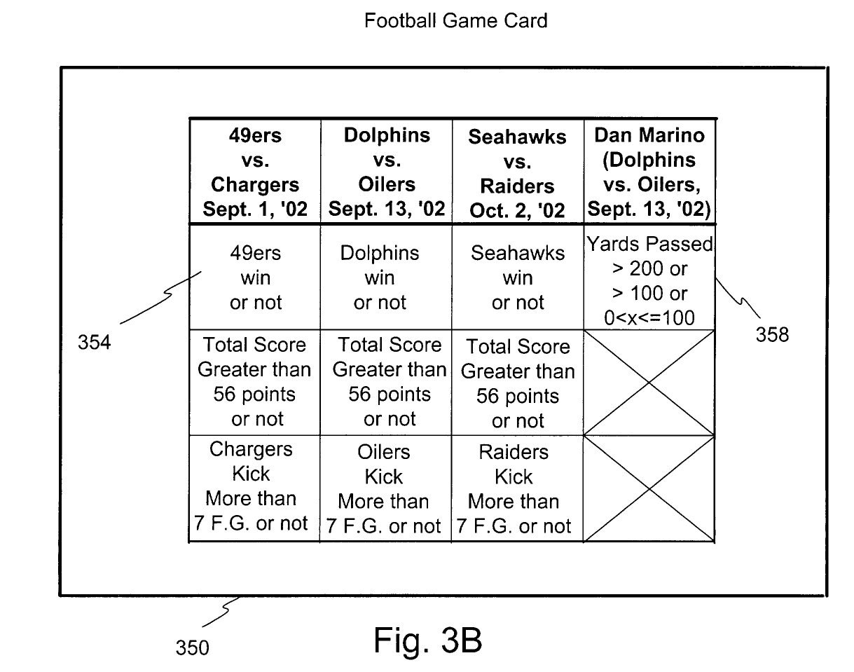

FIG. 3A illustrates a game card for a class of game cards configured for team contests. In this example embodiment of team contest game cards, participants or teams and their respective contests are represented in the team row 308 of the game card. Here, a contest signifies a competitive game played between a team against another team. Hence, there are N contests represented in the game card 304. The game card 304 representation is an example and there may be other ways to represent team contests.

There are a total of M event blocks 312 in which a bettor may select a desired outcome. Specific parameters (i.e., time, occurrence, location, participant) may describe the event represented in each event block 312. The types of events represented in the event blocks 312 may not be the same because the parameters may differ, as shown by event blocks 312A and 312B. The number of event blocks 312 for which a bettor must select outcomes affects the probability of attaining a perfect ticket. Each event block 312 is associated with a number of possible event outcomes. In one embodiment, the bettor may select one of two or more outcomes per event block 312. In general, the bettor will make outcome selections for a number (as specified by rules of play) of event blocks 312; he will select an event outcome per event block 312 to complete a game card 304 wager. The process of determining a winner of a team game card is generally similar to that described previously, and hence it is not described in detail again.

There are a multitude of parameters which may be used to define possible events in team sports betting. In order to specify the event outcomes, it is essential to specify the various parameters associated with the particular outcome. As mentioned previously, these parameters include occurrence, time, location, and participant parameters. The occurrence parameter specifies a measurable quality relating to a contest. Typical examples include winning or losing team, spread between scores of two teams being higher than a certain number, field goals exceeding a particular number, etc. Another example of an occurrence parameter may be points scored in a game by a particular team exceeding a particular number. The participant parameter indicates the entities engaging in the contest. For example, the participant may be an individual of a football team, one of two teams competing against each other, a subset of members of either or both teams, or both teams combined. As described previously in horse racing, the location parameter indicates where the contest occurs. For example, a bettor may be allowed to make a wager on a contest that occurs at one of several stadiums. The time parameter identifies a contest within a sequence and provides the date and time a it occurs. For example, a bettor may place a bet based on an outcome which occurs at halftime for a football contest that plays on a particular day and time.

A discussion and game card example will be provided on the various parameters for the example sport of football. This discussion should not be construed as a list of all possible parameters. Instead, it is provided to show the breadth the events may assume based on such parameters. After being made aware of the various possible parameters, it is contemplated that one of ordinary skill in the art may devise other events that do not depart from the scope of the claims.

For the sport of football, it is contemplated that an event represented by an event block 312 may be characterized by an occurrence parameter (i.e., point spread below 5) or a combination of several occurrence parameters (i.e., point spread below 5 and total score above 20), a time parameter (when the football game occurs or over what period of time the occurrence parameter is being measured), location parameter (where the football game is being held if similar games are occurring), and participant parameter (one or a number of members of the team or teams is being measured). It is contemplated that other occurrence parameters may comprise the following: passing yards, number of touchdowns, number of fumbles, number of sacks, total rushing yards, % pass completion, number of field goals, total number of field goals kicked in a game, receptions, total interceptions, fumbles recovered, conversion percentage, longest rushing yards in a carry, longest touchdown, or any other decision based on a measurable factor associated with the sport of football. It is contemplated that combinations or permutations of parameters that include occurrence, time, location, and participant parameters may be used to characterize the possible events represented in the event blocks 312 for a football contest or any contest.

As an example, each of four example event blocks 312 in a game card 304 can be defined in terms of its occurrence, participant, time and location parameters. In this example, the time and participant parameters define the location parameter; as a result, the location parameter need not be defined. The event blocks may be defined by the following example occurrence parameters: 1) team A wins or loses; 2) total score above 56 points; 3) Team B kicked more than 7 field goals; 4) total number of yards passed by an individual C is above 100 yards or above 200 yards.

The event blocks may be further defined in terms of participant parameters: 1) San Francisco 49ers vs. San Diego Chargers; 2) Miami Dolphins vs. Houston Oilers; 3) Seattle Seahawks vs. Los Angeles Raiders; and 4) QB Dan Marino in Miami Dolphins vs. Houston Oilers game.

The event blocks are further defined in terms of time parameters: 1) San Francisco 49ers vs. San Diego Chargers game on Sep. 1, 2002; 2) Miami Dolphins vs. Houston Oilers game on Sep. 13, 2002; and 3) Seattle Seabawks vs. Los Angeles Raiders game on Oct. 2, 2002; 4) Halftime results relating to participant (QB Dan Marino in Miami Dolphins vs. Houston Oilers game), time (on Sep. 13, 2002), and occurrence (total number of yards passed by an individual is less than 200).

The resulting game card 350 is shown in FIG. 3B. As illustrated, the top row indicates the seven participants and three time parameters that apply in the contests. There are a total of 10 event blocks 354 represented in the game card 350. The occurrence parameters are displayed within each event block 354. When making a wager, a bettor will select one of two outcomes for each event block 354 except for the Dan Marino event block 358, in which one of three outcomes may be selected. As a note, six of the participants are teams, while the seventh participant is an individual member of a team.

Examples of team contests that may be used to implement game cards include, but are not limited to, NFL football, NCAA football, NBA basketball, NCAA men's basketball, WNBA basketball, NCAA women's basketball, Major League Baseball, Major League Soccer, NHL hockey, and the like. Game cards for special sports events may be implemented as well and include the NBA playoffs, NBA championships, Major League Baseball playoffs, Major League Baseball World Series, NCAA baseball playoffs, NFL playoffs, NFL Superbowl, NCAA bowl games, and NHL playoffs.

Examples of statistics used to formulate parameters for baseball may comprise the following: earned run average, batting average, saves, wins, strikeouts, hits, doubles, triples, home runs, RBIs, steals, walks, complete games pitched, innings pitched, shutouts, strikes pitched, games played, bunts, extra innings, differences or sums or percentages or ratios of any of the previously mentioned statistics, or any other statistic as may be contemplated by one of ordinary skill in the art.

Examples of statistics used to formulate parameters for basketball may comprise the following: points scored, assists, rebounds, steals, blocks, number of free throws, 3 pointers, triple doubles and the like, differences or sums or percentages or ratios of any of the previously mentioned statistics, or any other statistic as may be contemplated by one of ordinary skill in the art. It is contemplated that these statistics may be used in formulating occurrence parameters that may be used to specify event outcomes in this type of team sport.

Examples of statistics used to formulate parameters for hockey may comprise the following: win/lose, goals, assists, points, saves, penalties, shots, offensive/defensive goal tending, fouls, penalty minutes, power play goals, power play assists, power play points, short handed goals, short handed assists, short handed points, game winning goals, shots on goal, shooting percentage, bud light plus/minus, hits, faceoff percentage, giveaways, takeaways, shifts per game, ice time, shutouts, penalty kill percentage, differences or sums or percentages or ratios of any of the previously mentioned statistics, or any other statistic as may be contemplated by one of ordinary skill in the art.

Examples of statistics used to formulate parameters for soccer may comprise the following: win/lose, goals, assists, points, saves, penalties, shots, shots on goal, blocks, fouls committed, fouls suffered, corner kicks, ejections, point streaks, goals streaks, assist streaks, offsides, cautions, shutouts, overtime wins/losses, minutes played per person, differences or sums or percentages or ratios of any of the previously mentioned statistics, or any other statistic as may be contemplated by one of ordinary skill in the art.

It is contemplated that the statistics used to formulate parameters as previously mentioned for many sports, may be calculated over varying time frames, i.e., per game, per tournament, per year, per season, etc.

Game Card for Match-Up Sports

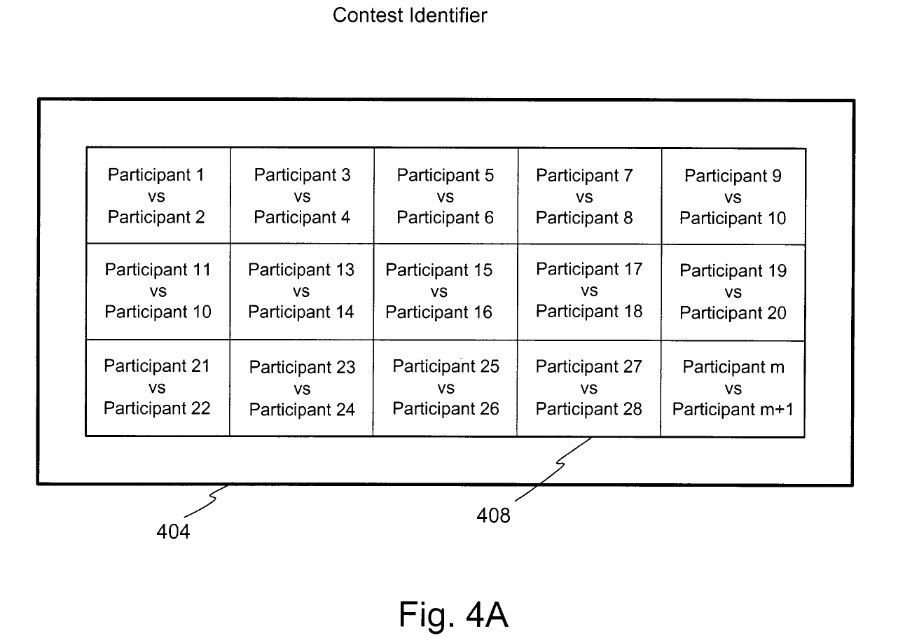

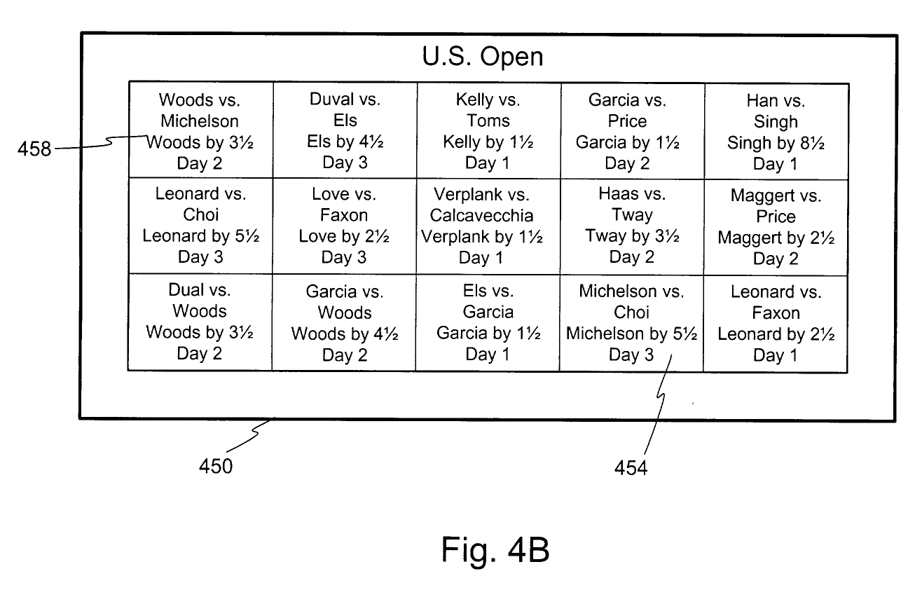

FIG. 4A illustrates one embodiment of a match-up game card 404. Examples of match-up sports that may be used in match-up include, but are not limited to, PGA golf, SPGA golf, LPGA golf, European PGA, NASCAR, Busch series auto racing, men's tennis, women's tennis, and the like. It is further contemplated that match-up game cards may be wagered in relation to the following sports events: US Open, The Masters, French Open, Wimbledon, Indy 500, or any other sports event as may be contemplated by one of ordinary skill in the art.

As illustrated in FIG. 4A, the game card 404 comprises (m+1)/2 event blocks 408. There are a total of m+1 participants. In the example game card 404 shown in FIG. 4A, an event within the event block 408 illustrates a participant being matched-up with another participant in a contest. As previously described, the event is characterized by a number of parameters (time, location, occurrence, and participant). These parameters will generate outcomes that a bettor may select on the game card 404. An example illustration of the participant parameter is provided in FIG. 4A. The event block 408 shows participant #27 being matched-up with participant #28. In this embodiment, the term “contest” implies a tournament or competition in which a participant is matched-up with a like participant. The participants may comprise one or more players (such as a player, two players in a team, or a group of players in a team), or may be some other entity, such as a robot or the like. There may be two or more possible outcomes per event block 408 of which one outcome may be selected by a bettor on the game card 404. The bettor makes outcome selections from a predetermined number of event blocks 408 as required by the rules of play. The number of points awarded per game card 404 may be correlated to the odds that a specific event outcome will occur as determined by a pari-mutuel betting system or some other system.

Examples of statistics used to formulate parameters for golf may comprise the following: overall score in a round of golf, putting distance, longest drive, number of eagles, number of birdies, number of bogeys, number of saves, differences or sums or percentages or ratios of any of the previously mentioned statistics, or any other statistic as may be contemplated by one of ordinary skill in the art. It is contemplated the statistics may be calculated over varying time frames, i.e., per game, per tournament, per year, per season, etc. In order to eliminate a tie score in the sport of golf, it is contemplated that one player or team will be given a score that is a half stroke less than the other player. This system facilitates game card betting because, due to the advantage provided to one participant, a participant will presumably win over another participant when the score is tied.

In the sport of tennis, statistics used to formulate parameters include: number of aces, number of faults in a match by a player, winning a match, set score, length of match, differences or sums or percentages or ratios of any of the previously mentioned statistics, or any other statistic as may be contemplated by one of ordinary skill in the art. It is contemplated the statistics may be calculated over varying time frames, i.e., per game, per tournament, per year, per season, etc.

In the sport of auto racing, statistics used to formulate parameters include: pole position at finish, number of pit stops, number of accidents, number of laps, top speed, best lap time, differences or sums or percentages or ratios of any of the previously mentioned statistics, or any other statistic as may be contemplated by one of ordinary skill in the art. Again, it is contemplated the statistics may be calculated over varying time frames, i.e., per game, per tournament, per year, per season, etc.

As an illustrative example of the match-up sport of tennis, a game card 450 is shown in FIG. 4B. As illustrated, there are a number of players (participant parameter) matched-up against each other in this golf tournament (contest). There are a total of 15 event blocks 454 represented in the game card 450. The events are displayed within each event block 454. In these events, the occurrence parameter is whether a player shoots at least a specified handicap compared with another player. For example, the first event block 458 indicates that Michelson has a 3 stroke handicap against Woods. When making a wager, a bettor will make a number of outcome selections per game card and will select one of two outcomes for each event block 354. Should the bettor make a selection on the first event block 458, he may select that Woods will score 3 or more strokes above Michelson for Day 2 (time parameter). In this embodiment, the location parameter (U.S. Open) is a constant and is not a factor that modifies the outcomes for the events listed.

In each type of game card match-up, it is contemplated that an appropriate number of points are awarded for each winning outcome in a bettor's game card 404. Points awarded may be based on odds provided over a pari-mutuel wagering system, although other types of systems may be used to calculate such odds.

General and Perfect Ticket Pools

A game card awarded the largest number of points wins a general pool of money for a particular set of outcomes selected on a game card for that particular round of game cards. As discussed briefly above, a perfect ticket pool is a pool of money that is segregated from the general pool and may be awarded to a bettor holding a ticket either having a maximum point value, a maximum number of winning outcomes, or a predetermined number of points or outcomes. It is contemplated that the method of calculating a perfect ticket award is provided to bettors prior to commencement of betting of a particular game card. When points are awarded for winning outcomes, a ticket having a maximum point value calculated after all outcomes in a game card are realized is termed a perfect ticket. A perfect ticket pool is a separate pool of money distinct from the general pool used to pay out a winner(s) in a typical sports game. In one embodiment, a game card's bet is six dollars, and for each six dollars bet, one dollar goes to an accumulating perfect ticket pool and the remaining five dollars funds the general pool. Any percentage may be allocated to the perfect ticket pool and the general ticket pool. The general pool may be awarded to the winner of each game card round. A game card round is a period of time defined by the end of collections for all game card selections and wagers associated with a particular set of event blocks. In addition, all selections are processed and any pay-outs are made to winners associated with that particular collection of game cards.

The monies, after deducting management expenses, are held in a general pool to pay the winning game card. As previously mentioned, a bettor holding a game card with a maximum number of points awarded over all winning outcomes, a maximum number of winning outcomes, or a predetermined number of outcomes or points awarded to a game card may be selected the winner of the perfect ticket pool.

Because the perfect ticket pool accumulates, it may grow to a significant amount of money in relation to the amount bet. As an advantage to the method and apparatus described herein, the large pool of money will stimulate bettors' interest in betting because the payoff may be life changing. Should a perfect ticket pool be depleted as a result of an award to a perfect ticket winner, a back-up pool may be created to maintain the existence of a perfect ticket pool. This provides the advantage of maintaining bettor interest and participation. It is contemplated that a smaller percentage of what is contributed to the perfect ticket pool may be contributed to a back-up pool. Should the gaming facilitator wish additional insurance, a secondary “back-up pool” may be created.

It is contemplated that a small percentage of every bet or wager is contributed to such back-up pool(s). In situations that have a secondary back-up pool, it is contemplated that any additional contributions to the primary backup pool are diverted to the secondary backup pool after the first backup pool has reached a particular amount.

As a monetary example, for every $6 game card wager, $1 may be contributed to a perfect ticket pool, $0.50 may be contributed to a primary back-up pool, $0.25 may be contributed to a secondary back-up pool, $0.25 may be deducted for management expenses, while the remaining $4.00 is used to fund the general pool to pay out the winner(s) of the winning game card(s).

If allowed by the gaming control board in a state, a seasonal carryover of the perfect ticket pool at the end of the last event of a season for a contest may provide continuity of the game from season to season. For example, if the football season ended with no perfect tickets, then the perfect ticket pool may carry over to next season. Otherwise, the state may require the award of the perfect ticket payout to the ticket with the most points in the last event of the season. This may provide an enhanced incentive to a bettor to bet upon the final game of the season.

In cases where there is more than one winner having a perfect ticket, the pool would be appropriately divided based on the amounts wagered per individual or any other basis. Similarly, in cases where there is more than one winner for the general pool, the pool would be divided proportionately to the winning individuals based on amount wagered.

In cases where no bettor attains a “perfect ticket,” it is contemplated the bettor(s) with the highest value game card 204 may win the general pool for that game and or a portion of the general pool.

Tournament Betting Operations

Tournament style game card betting involves selection of outcomes on a game card related to a number of sequential events. In this game, the bettor having a game card with the highest point score at the end of the sports tournament wins the general pool. Numerous pools may be created with various winners at each stage of the tournament.

One example relates to an annual NCAA basketball tournament called March Madness. This basketball tournament comprises four sets of 16 teams for a total of 64 basketball teams. In this type of contest, the teams are paired for competition over many rounds of play. After one round of play, losing teams are eliminated, while winning teams advance to a next round of play. Two teams remain in the last round of play, in which one team prevails as winner of the tournament. The teams are arranged to compete in each round of play based on their rank or their odds of beating a top ranked team. In this embodiment, the points awarded for a successful outcome (i.e. selecting a winning team in one basketball game) may be based on predetermined odds or odds provided by a pari-mutuel betting system. Although the number of correct winning outcomes may be greater in a first game card as compared with that of a second game card, the second card may fare better on a point basis because of differences in points awarded per winning outcome due to differences in odds. In one example embodiment, points are based on the teams ranking in the tournament. Thus, a win by a team ranked last, i.e. 16, may be worth more points than a team ranked first. As a result, a strategy to accumulate the largest number of points per tournament game card, based on an analysis of a team's anticipated performance along with their odds of winning, may be used by the bettor to add excitement to the wager.

It is contemplated that the NBA playoffs, NFL playoffs, any tennis tournament, or any other series or sequence of competitive games emulating a tournament style of play may be contemplated by one of ordinary skill in the art.

Method of Processing a Game Card

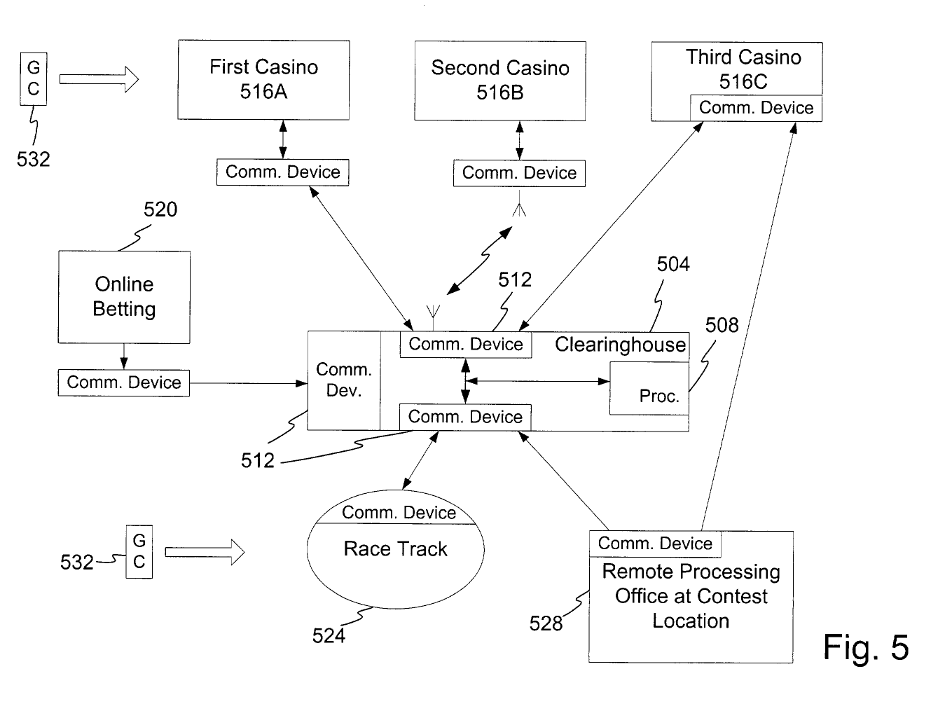

FIG. 5 illustrates a block diagram of an example system for use in operations and processing of game card bets. A clearinghouse 504 comprises the central processing center of the system. The clearinghouse 504 comprises a processor 508 and various communication device interfaces 512. The clearinghouse 504 may comprise a central processing center used to determine the total amounts wagered, the number of bets wagered, and the specific outcomes selected per each wagered game card (GC) 532. It is contemplated the clearinghouse 504 may also calculate pari-mutuel odds associated with any outcome. It is also contemplated that the clearinghouse 504 may generate the appropriate pari-mutuel pay outs for all winning gaming cards based on the odds per outcome for each event block and the amounts wagered.

As illustrated, the clearinghouse 504 contains a number of communication devices 512 used to communicate gaming data between various entities and the clearinghouse 504. The various entities may include one or more casinos 516A, 516B, 516C, one or more online betting companies 520, one or more race tracks 524, one or more remote processing offices 528 located at a sport contest location, or any other location capable of receiving betting cards.

A completed game card (GC) 532 with associated bet is submitted by a bettor at a casino 516, online betting company 520, race track 524, or a remote processing office 528. The remote processing office 528 may be located near a sports contest, such as an example football game or race track. The bets from such bettors may be communicated by wired or wireless communication with the clearinghouse 504. The online betting company 520 may utilize the Internet to communicate to the clearinghouse 504. The casinos 516A, 516B, 516C, online betting company 520, race track 524, or remote processing office 528 may employ a sports book facility to dispense tickets and game cards to the bettors. These peripheral facilities provide a venue for interaction and interface between the bettor and the clearinghouse 504 such that the bettor can facilitate selecting outcomes associated with events in a game card(s).

The clearinghouse 504 acts as a distribution facility of monies collected during rounds and to determine winning game cards. Since all game card data is provided to the clearinghouse 504, the clearinghouse is able to process all the game card data to determine which game card is the winning game card. The clearinghouse 504 apportions monies to a general pool, a perfect ticket pool, a primary back-up pool, a secondary back-up pool (if required), and a management expense account. The clearinghouse 504 may also act to disseminate monies to the appropriate facilities 516, 520, 524 after a particular contest or round has occurred. In addition, the clearinghouse 504 may disseminate money to gaming entities or intermediaries that are involved in facilitating the wagering event. It is contemplated the clearinghouse 504 may account for and transfer monies to governmental agencies who may generate revenues.

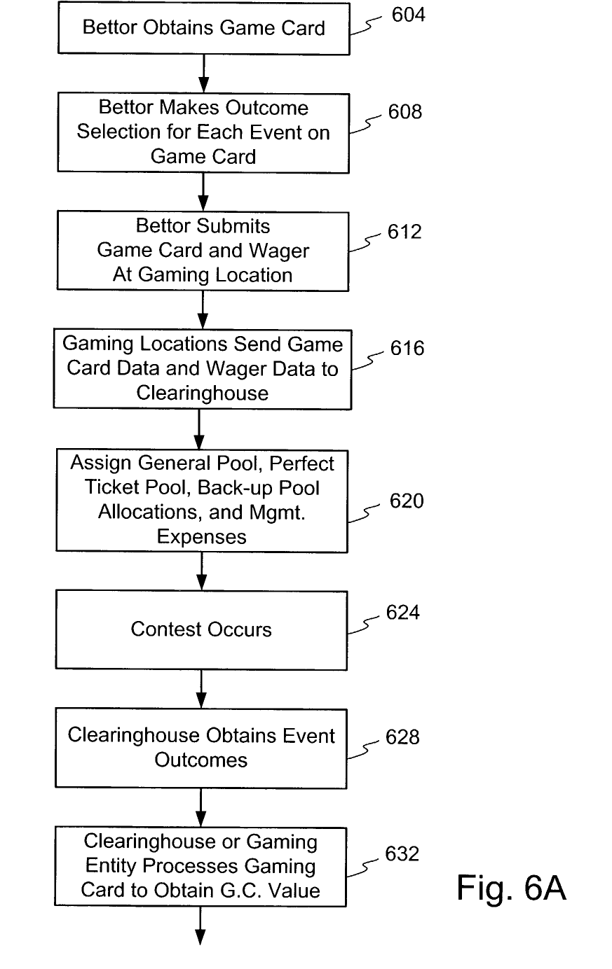

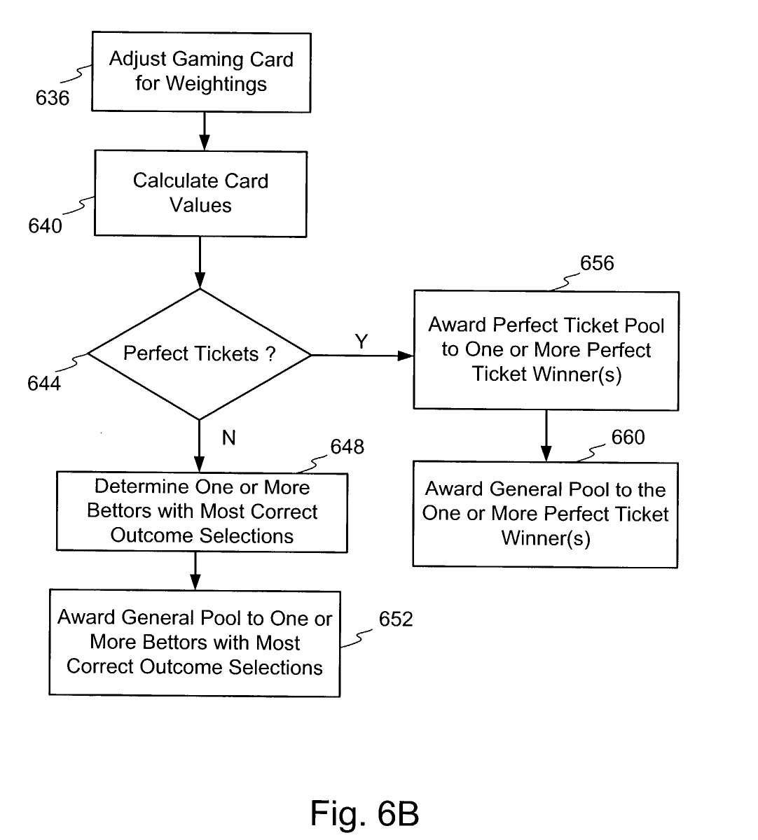

FIG. 6A illustrates an operational flow diagram describing an example method of processing a game card. At a step 604, a bettor obtains a game card from a casino, online betting company, race track, or remote processing office. At a step 608, the bettor makes outcome selections as represented on the game card event blocks. The bettor may select one of several outcomes represented in an event block on the game card. The bettor may need to make outcome selections from one or more event blocks as dictated by the rules of play by the gaming organizers of the gaming facility. The bettor will indicate his outcome selections on the game card by a marking tool such as a pen or a pencil. When betting through an online betting facility from a computing device, it is contemplated that the bettor may input his outcome selections on a virtual game card displayed on the computing device's screen.

At a step 612, the bettor submits his game card and wager to the gaming facility at the gaming location. It is also contemplated that the gaming facility may be an individual's computer and that the gaming location may be an individual's home when the method of wagering is performed by online betting. Furthermore, bets may be called in via a telephone or entered via a stand-alone kiosk device. At a step 616, the gaming facility (a casino, online betting company, race track, or remote processing office, or similar processing facility) sends the game card data to a clearinghouse for processing. At a step 620, the clearinghouse assigns appropriate percentages of the collected wagers to the general pool, perfect ticket pool, back-up pool(s), and management expenses account. At a step 624, the sport contest occurs. The contest may be a horse race, a dog race, a football game, a basketball game, a tennis match, an auto race, a golf tournament, or any other contest.

At a step 628, the clearinghouse obtains all outcome selections made by all bettors associated with the game card. It is contemplated that data associated with outcome selections is transmitted by either wireline or wireless transmission to the clearinghouse. The transmission may be one of many different data protocols. It is contemplated that the Internet may be a medium in which the data is transmitted. At a step 632, the clearinghouse processes all game cards and assigns point values for outcomes. Points may be assigned based on odds generated by a pari-mutuel type betting system, a predetermined odds generating system, or any other system capable of generating odds. At steps 636 and 640, the points are totaled for each game card based on all winning outcomes and associated odds. As a result, more points would be assigned to an outcome that had a lower probability of occurring. At a step 644, the processor determines whether a winning perfect card was issued. If a perfect ticket winner exists, at a step 656, the perfect ticket pool is awarded to the individual(s) possessing the winning game card. At a step 660, the general pool may also be awarded to the individuals claiming the perfect ticket pool.

If no perfect ticket was issued, the processor at the clearinghouse determines the game card(s) that have the highest points scored or awarded based on the bettor's selection of outcomes. This is shown at step 648. At a step 652, the bettor(s) with the highest point score is awarded the general pool or portion thereof. The pools may be divided between more than one winner. The general pool may be divided amongst the bettors holding the top three game cards in terms of total points awarded. For example, the bettor possessing the game card with the highest total points awarded may be awarded 70% of the general pool, the bettor holding the game card with the next highest number of points may be awarded 20%, while the bettor holding the game card with the third highest number of points may be awarded 10%. It is contemplated that the percentages may be varied.

The preferred media in which event outcomes are selected is by a game card as discussed previously. To permit flexibility in betting, it is contemplated a game card may be virtually displayed at a kiosk, computer, personal digital assistant (PDA), web enabled cell phone, or any like device where a touch screen, mouse, pointing tool, or keyboard provides a means to select various possible outcomes in a contest.

It will be understood that the above described arrangements of apparatus and the method therefrom are merely illustrative of applications of the principles of this invention and that many other embodiments and modifications may be made without departing from the spirit and scope of the invention as defined in the claims.

I/we claim:

1. A method of wagering by one or more bettors comprising the steps of:
obtaining a game card that comprises an identification of two or more events associated with one or more contest, wherein each event is associated with an event outcome;
selecting one or more event outcomes for the two or more events to create a completed game card;
submitting the completed game cards and a wager to a gaming facility configured to accept and process completed game cards; and
selectively receiving a monetary award based on the number of points awarded on a completed game card.

2. The method of claim 1, wherein all or part of the wagers are collected in a pool to be awarded to a bettor having the game card with the highest point score.

3. The method of claim 1, wherein a portion of the wager is allocated to a perfect ticket pool.

4. The method of claim 1, wherein the gaming facility comprises an entity selected from the group consisting of a casino, an on-line betting facility, or a horse race track.

5. The method of claim 1, wherein an event comprises one or more parameters.

6. The method of claim 1, wherein processing game cards comprises determining which game card has the most correct event outcome selections.

7. The method of claim 1, further comprising selectively receiving a perfect ticket pool award if the processing determines that the game card is awarded a maximum point total after all event outcomes have been realized.

8. The method of claim 1, wherein the number of points is based on a weighted point basis.

9. A method of wagering by one or more bettors comprising the steps of:
providing a medium by which bettors may provide outcome selection data on future events of future contests;
receiving outcome selection data and associated wagers from a bettor, the wagers for deposit into one or more monetary pools;
processing the outcome selection data provided by the bettor;
assigning a point total to selection outcome data based on actual outcome of one or more events;
comparing selection outcome data determining one or more bettors with highest point scores; and
paying bettors with the highest point scores from the one or more monetary pools.

10. The method of claim 9, wherein at least one of the one or more monetary pools comprises a perfect ticket pool.

11. The method of claim 9, further comprising transmitting the processed outcome selection data to a central processing facility for further processing.

12. The method of claim 11, wherein the central processing facility comprises a clearinghouse or casino.

13. The method of claim 12, wherein the data processing facility determines odds associated with all winning outcomes and assigns point values.

14. The method of claim 9, wherein the providing media comprises providing a game card via an image of a game card on a display.

15. The method of claim 9, further comprising paying bettors from a perfect ticket pool if a bettor's game card attains a maximum point score.

16. The method of claim 9, further comprising paying bettors from a perfect ticket pool if a bettor's game card attains a maximum number of winning outcomes.

17. The method of claim 9, further comprising paying bettors from a perfect ticket pool if a bettor's game card attains a predetermined number of winning outcomes.

18. The method of claim 9, further comprising paying bettors from a perfect ticket pool if a bettor's game card attains a predetermined point score.

19. The method of claim 13, wherein the events are comprised of one or more parameters selected from the group of parameters consisting of occurrence parameter, time parameter, and participant parameter.

20. The method of claim 13, wherein the types and number of events varies the probability of generating a maximum point score.

21. A method of placing a bet by a bettor comprising the steps of:
selecting one or more outcomes from two or more possible outcomes associated with events listed on a game card;
submitting the game card to a processing center for processing;
submitting a wager for each game card submitted; and
obtaining a receipt indicating the outcomes selected.

22. The method of claim 18, wherein the events occur during contests selected from the group of contests consisting of horse racing, dog racing, jai alai, football, baseball, basketball, soccer, hockey, auto racing, tennis, and golf.

23. The method of claim 18, wherein the processing center comprises a casino.

24. The method of claim 18, wherein the event comprises a tournament of play.

25. The method of claim 18, wherein the event outcomes are determined during a contest.

26. The method of claim 18, further comprising receiving the game card at a racing track.

27. A game card configured to specify outcome selections by a bettor comprising:
one or more contest rows configured to define one or more contests to which the game card relates;
one or more event blocks configured to define one or more events, each event having two or more event outcomes;
a bet line configured to define a bet amount associated with the gaming card; and
wherein the gaming card is configured to allow a bettor to indicate:
event outcomes for at least two of the two or more events; and
a bet utilizing the bet line.

28. The game card of claim 27, wherein the game card medium is comprised of paper and ink.

29. The game card of claim 27, wherein the game card is presented via a video display or LCD.

30. The game card of claim 27, wherein the game card comprises 15 event blocks.

31. The game card of claim 27, wherein the game card is configured for tournament play.

32. A system for processing a game card and associated wager, the game card containing outcome selections of events in a contest, the outcome selections comprising game card data, the system comprising:
one or more first facilities configured to accept game cards and associated wagers submitted by bettors and distribute winnings; and
one or more second facilities configured to process game card data received from the one or more first facilities, the second facilities further comprising:
a first communication device configured to receive game card data from the one or more first facilities;
a second communication device configured to receive contest data regarding events at a contest; and
a processor configured to compare the game card data to the contest data.

33. The system of claim 29, wherein the one or more first facilities comprise one or more casinos.

34. The system of claim 29, wherein the one or more second facilities comprise one or more clearinghouses.

35. The system of claim 29, wherein the game card data comprises the outcome selections on a game card.
